(19) United States
(12) Patent Application Publication
(10) Pub. No.: US 2024/0363111 A1
(43) Pub. Date: Oct. 31, 2024

(54) SUMMARIZING SYSTEM, SUMMARIZING METHOD, AND RECORDING MEDIUM

(71) Applicant: Takeshi Shikama, KANAGAWA (JP)

(72) Inventor: Takeshi Shikama, KANAGAWA (JP)

(73) Assignee: Ricoh Company, Ltd., Tokyo (JP)

(21) Appl. No.: 18/626,666

(22) Filed: Apr. 4, 2024

(30) Foreign Application Priority Data
Apr. 27, 2023 (JP) 2023-073614

(51) Int. Cl. G10L 15/22

(52) U.S. Cl. CPC G10L 15/22

(57) ABSTRACT

A system, method, and a program stored on a non-transitory recording medium, each of which: acquires speech; converts the speech into a plurality of texts; generates a summary of the plurality of texts when the plurality of texts satisfy a summarizing execution condition; and outputs the summary to a user.

### CROSS-REFERENCE TO RELATED APPLICATIONS

This patent application is based on and claims priority pursuit to 35 U.S.C. § 119 (a) to Japanese Patent Application No. 2023-073614, filed on Apr. 27, 2023, in the Japan Patent Office, the entire disclosure of which is hereby incorporated by reference herein.

### BACKGROUND

### Technical Field

The present disclosure relates to a summarizing system, a summarizing method, and a recording medium.

### Related Art

The summarizing system generates summary sentences from speech data. For example, the summarizing system converts speech contents made by a plurality of persons during conversations into texts, displays the converted texts for selection, and generates a summary including one or more texts of the converted texts that are selected by a user.

### SUMMARY

Example embodiments include a system, method, and a program stored on a non-transitory recording medium, each of which: acquires speech; converts the speech into a plurality of texts; generates a summary of the plurality of texts when the plurality of texts satisfy a summarizing execution condition; and outputs the summary to a user.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example system configuration of a summarizing system according to an embodiment;

FIG. 2 is a diagram illustrating an example hardware configuration of a computer;

FIG. 3 is a diagram illustrating an example functional configuration of the summarizing system of FIG. 1;

FIG. 4 is a diagram illustrating an example data structure of the summarizing system;

FIGS. 5A and 5B (FIG. 5) are a sequence diagram illustrating example processing of summarizing, performed by the summarizing system;

FIGS. 6A and 6B are diagrams illustrating example display screens, displayed at a terminal apparatus of the summarizing system;

FIG. 7 is a diagram illustrating an example display screen, displayed at the terminal apparatus of the summarizing system;

FIG. 8 is a diagram illustrating an example display screen, displayed at the terminal apparatus of the summarizing system;

FIG. 9 is a flowchart illustrating example processing of determining, according to a first example;

FIG. 10 is a diagram for explaining the determination processing according to the first example;

FIG. 11 is a flowchart illustrating example processing of determining, according to a second example;

FIG. 12 is a diagram for explaining the determination processing according to the second example;

FIG. 13 is a sequence diagram illustrating example processing of updating a summary;

FIG. 14 is a sequence diagram illustrating example processing of re-generating a summary according to a first example;

FIGS. 15A and 15B are diagrams for explaining the processing of re-generating a summary according to the first example;

FIGS. 16A and 16B are diagrams for explaining the processing of re-generating a summary according to a second example;

FIG. 17 is a sequence diagram illustrating example processing of re-generating a summary according to the second example; and

FIG. 18 is a sequence diagram illustrating example processing of re-generating a summary according to a third example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### System Configuration

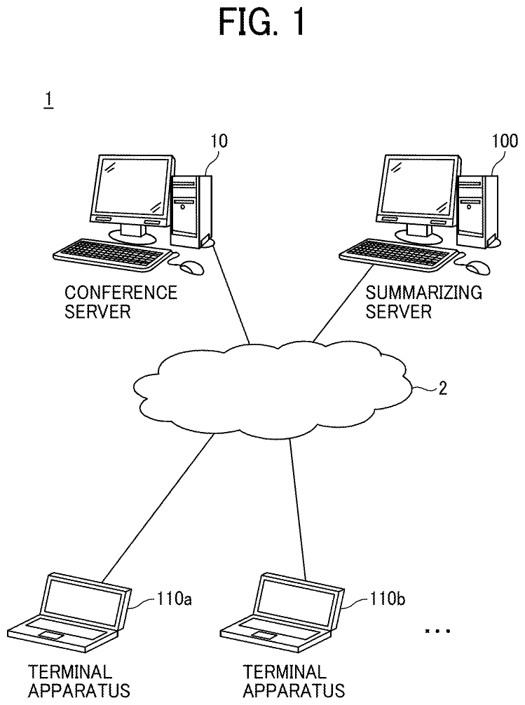

FIG. 1 is a diagram illustrating an example system configuration of a summarizing system according to an embodiment. The summarizing system 1 includes a summarizing server 100 and a plurality of terminal apparatuses 110a, 110b . . . , which are connected to a communication network 2 such as the Internet and a local area network (LAN). In the following description, any one of the terminal apparatuses 110a, 110b . . . , is referred to as a “terminal apparatus 110”. The number of terminal apparatuses 110 illustrated in FIG. 1 is an example such that the number of terminal apparatuses 110 may be two or more.

The summarizing system 1 summarizes conversations of a user who uses the terminal apparatus 110, and provides the user with the latest summary. For example, the summarizing system 1 summarizes speech contents obtained during a web conference, in which a user using the terminal apparatus 110a and a user using another terminal apparatus 110b communicate via the conference server 10, and distributes the summarized text to the terminal apparatuses 110a and 110b. The conference server 10 may be a server outside the summarizing system 1 or a server inside the summarizing system 1.

The summarizing system 1 summarizes conversations such as during a general meeting held by users face-to-face. In the following example, it is assumed that the summarizing system 1 summarizes speech contents of a web conference (hereinafter, referred to as a conference), and distributes the summarized text to the terminal apparatuses 110 of the users participating in the conference.

The terminal apparatus 110 is a general-purpose information terminal such as a personal computer (PC), a tablet terminal, or a smartphone, which is used by a user. The terminal apparatus 110 is not limited to such examples, and may be a video conference terminal, or an electronic device capable of carrying out a web conference such as an interactive white board (IWB). The IWB is a whiteboard with the capability of mutual communication, which may be referred to as an electronic blackboard. In the following description, it is assumed that the terminal apparatus 110 is a general-purpose information terminal.

To participate in a particular web conference, the user accesses an address provided by the conference server 10 for the particular conference using, for example, a web conference application installed in the terminal apparatus 110, or a web browser.

The conference server 10 is, for example, an information processing apparatus implemented by a computer or an information processing system implemented by a plurality of computers. The conference server 10 provides a web conference service, which transmits or receives content data including speech between the plurality of terminal apparatuses 110. In the present embodiment, the web conference service provided by the conference server 10 may be any desired web conference service.

The summarizing server 100 is, for example, an information processing apparatus implemented by a computer or an information processing system implemented by a plurality of computers. The summarizing server 100 provides a summarizing service.

The configuration of the summarizing system 1 illustrated in FIG. 1 is merely an example. For example, in the summarizing system 1, the summarizing server 100 may perform the functions of the conference server 10. Further, the summarizing system 1 may not include the conference server 10.

### Overview of Processing by Summarizing System

In this example, it is assumed that, with the conference server 10, a user who uses the terminal apparatus 110a holds a web conference (hereinafter, simply referred to as a conference) with another user who uses the terminal apparatus 110b.

The terminal apparatuses 110a and 110b each activate an application program (hereinafter referred to as an app) compatible with the summarizing system 1 to acquire the speech made by the user, and transmit the acquired speech to the summarizing server 100.

The summarizing server 100 acquires speech transmitted from the terminal apparatuses 110a and 110b, and converts the acquired speech into a plurality of texts. When the plurality of texts satisfy a predetermined summarizing execution condition, the summarizing server 100 generates a summary of the plurality of texts and distributes the generated summary to the terminal apparatuses 110a and 110b.

In one example, it is determined that the summarizing execution condition is met when the amount (for example, a data size such as the number of characters) of the plurality of texts, converted by the summarizing server 100, reaches a first threshold value. In another example, it is determined that the summarizing execution condition is met when the similarity calculated from the plurality of texts converted by the summarizing system 1 is lower than a second threshold value (when the topic is changed).

The terminal apparatuses 110a and 110b may each display the summary distributed from the summarizing server 100 on a display screen of the application. Alternatively, the terminal apparatuses 110a and 110b may each display the summary on a conference screen of the web conference, while the summary is being superimposed on a display image of the conference screen.

Conventionally, it has been cumbersome for the user to select one or more texts to be summarized from a plurality of converted texts, thus, making it difficult for the user to check the latest summary during the conference.

In this embodiment, every time a plurality of texts satisfy the predetermined summarizing execution condition, the summarizing system 1 automatically generates a summary from the plurality of texts satisfying the condition and distributes the summary to the terminal apparatuses 110a and 110b used by the users. With the summarizing system, the user can easily check the most recent summary.

### Hardware Configuration

### Hardware Configuration of Computer

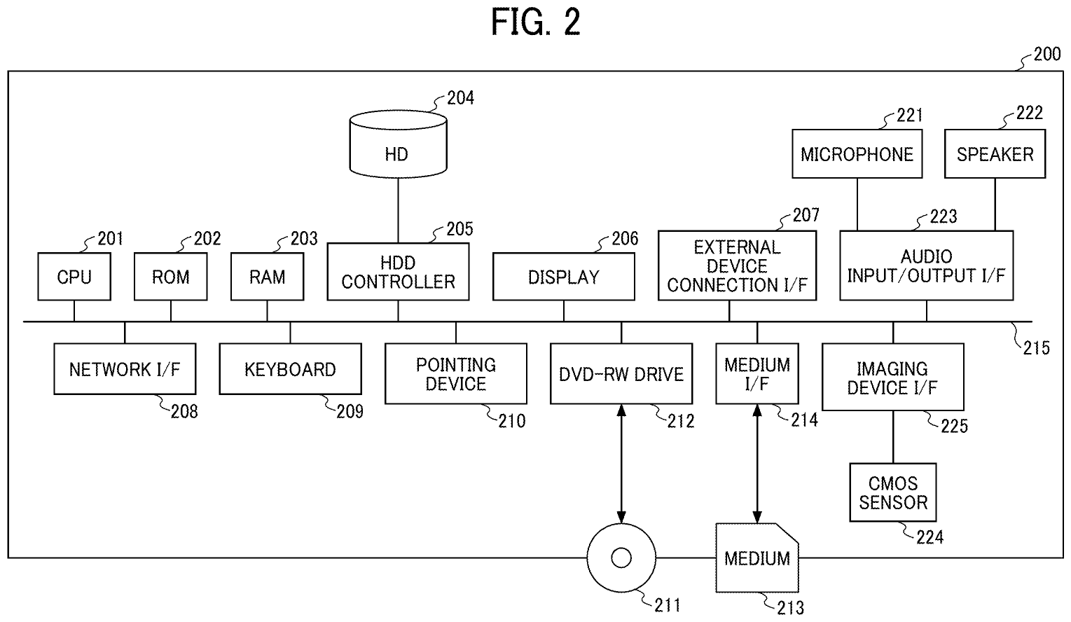

The summarizing server 100 has a hardware configuration substantially similar to that of a computer 200 illustrated in FIG. 2. Alternatively, the summarizing server 100 may be implemented by a plurality of computers 200. Similarly, the terminal apparatus 110 has a hardware configuration substantially similar to that of the computer 200.

FIG. 2 is a diagram illustrating an example hardware configuration of the computer 200. As illustrated in FIG. 2, the computer 200 includes, for example, a central processing unit (CPU) 201, a read only memory (ROM) 202, a random access memory (RAM) 203, a hard disk (HD) 204, a hard disk drive (HDD) controller 205, a display 206, an external device connection interface (I/F) 207, a network I/F 208, a keyboard 209, a pointing device 210, a digital versatile disk rewritable (DVD-RW) drive 212, a medium I/F 214, and a bus line 215.

When the computer 200 operates as the terminal apparatus 110, the computer 200 further includes, for example, a microphone 221, a speaker 222, an audio input/output I/F 223, a complementary metal oxide semiconductor (CMOS) sensor 224, and an imaging device I/F 225.

The CPU 201 controls entire operation of the computer 200. The ROM 202 stores a program such as an initial program loader (IPL) used for executing the CPU 200. The RAM 203 is used as a work area for the CPU 201. The HD 204 stores various programs such as an operating system (OS), applications, and device drivers. The HDD controller 205 controls reading and writing of various data from and to the HD 204 under control of the CPU 201. The HD 204, which operates with the HDD controller 205, is an example of storage devices provided with the computer 200.

The display 206, which may be a liquid crystal display, displays various information such as a cursor, menu, window, character, and image. The display 206 may be provided separately from the computer 200. The external device connection I/F 207 is an interface circuit that connects various external devices to the computer 200. The network I/F 208 is an interface circuit that connects the computer 200 to the communication network 2 to enable communication with other devices.

The keyboard 209 is one example of an input device provided with a plurality of keys for allowing a user to input characters, numerals, or various instructions. The pointing device 210 such as a mouse is another example of the input device, which allows the user to select or execute a specific instruction, select a target for processing, or move a cursor being displayed. The keyboard 209 and the pointing device 210 may be provided separately from the computer 200. In another example, the input device may be integrally provided with the display 206, for example, as a touch panel.

The DVD-RW drive 212 reads and writes various data from and to a DVD-RW 211, which is an example of a removable storage medium. Instead of the DVD-RW 211, any other removable storage medium may be used. The medium I/F 214 controls reading or writing (storing) of data from or to a storage medium 213 such as a flash memory. The bus line 215 includes an address bus, a data bus, various control signal lines, etc., which electrically connect the above-described components.

The microphone 221 is a built-in circuit that converts sound into an electrical signal. The speaker 222 is a built-in circuit that generates sound such as music or voice by converting an electrical signal into physical vibration. The audio I/O I/F 223 is a circuit that inputs an audio signal from the microphone 221 or outputs an audio signal to the speaker 222 under control of the CPU 201.

The CMOS sensor 224 is an example of a built-in imaging device that captures an object (for example, an image of the user) under control of the CPU 201 to obtain image data. The computer 200 may include any desired imaging device such as a charge coupled device (CCD) sensor instead of the CMOS sensor 224. The imaging device I/F 225 is a circuit that controls operation of the CMOS sensor 224.

The hardware configuration of the computer 200 illustrated in FIG. 2 is an example, and various modifications and applications can be made. In another example, the functions of the summarizing server 100 may be implemented by software programs that run on a physical machine, as well as on a virtual machine.

### Functional Configuration

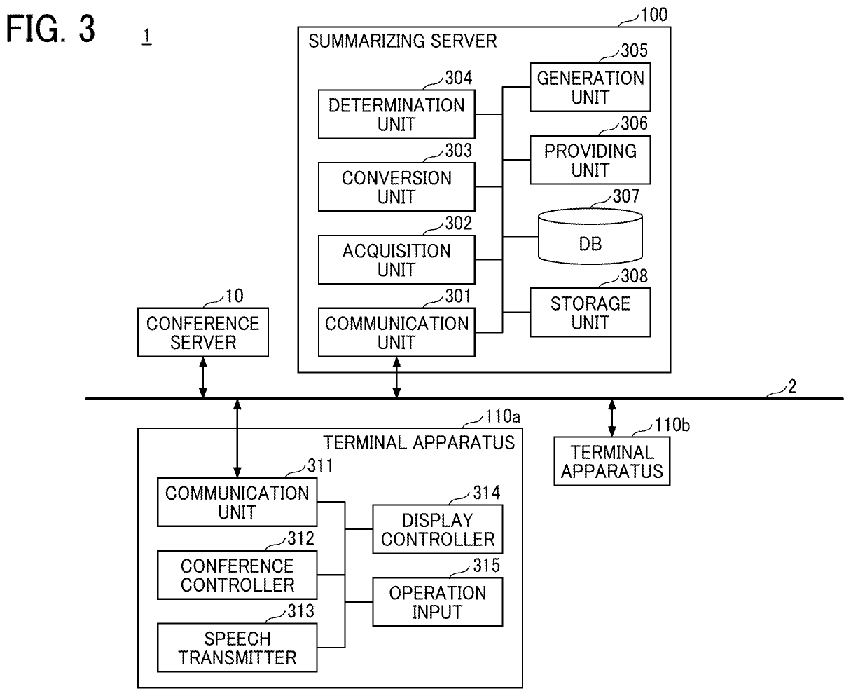

Next, an example functional configuration of the summarizing system 1 is described. FIG. 3 is a diagram illustrating an example functional configuration of the summarizing system 1.

### Functional Configuration of Terminal Apparatus

At the terminal apparatus 110, the CPU 201 executes a control program stored in, for example, the HD 204, to implement a communication unit 311, a conference controller 312, a speech transmitter 313, a display controller 314, and an operation input 315. At least a part of the functional configuration may be implemented by hardware such as the element described referring to FIG. 2. In FIG. 3, the terminal apparatus 110b has a functional configuration that is the same as that of the terminal apparatus 110a.

The communication unit 311 connects the terminals 110 to the communication network 2 using, for example, the network I/F 208, and performs communication processing for communicating with other devices such as the conference server 10, the summarizing server 100, and the other terminal apparatuses 110.

The conference controller 312 connects to the conference server 10 using the communication unit 311, for example, and transmits and receives content data including audio data collected during the conference (referred to as “conference audio”). For example, the conference controller 312 controls input and output of conference audio using the audio input/output I/F 223, and output of a content image (a conference image, a shared image, etc.) using the display 206. The above-described processing of controlling input and output, executed by the conference controller 312, is the same as processing generally carried out during the web conference.

The speech transmitter 313 executes processing of transmitting speech, which includes acquiring speech of the user who uses the terminal apparatus 110 and transmitting the speech to the summarizing server 100. For example, the speech transmitter 313 acquires speech (voice) collected by the microphone 221 from the audio input/output I/F 223, and transmits the collected speech to the summarizing server 100. The summarizing server 100 summarizes not only conversations during the web conference but also conversations during the on-site conference.

The speech transmitter 313 may acquire the speech of the user from the conference controller 312 and transmit the acquired speech to the summarizing server 100.

The display controller 314 controls a displaying unit, such as the display 206, to display various display screens described below. The operation input 315 receives operation input by the user, and may be implemented by the keyboard 209 or the pointing device 210. For example, the operation input 315 receives a user operation on the display screen displayed by the display controller 314.

### Functional Configuration of Summarizing Server

At the summarizing server 100, the CPU 201 executes a control program stored in, for example, the HD 204, to implement a communication unit 301, an acquisition unit 302, a conversion unit 303, a determination unit 304, a generation unit 305, a providing unit 306, and a database (DB) 307. The DB 307 operates with any desired memory such as the HD 204. At least a part of the functional configuration may be implemented by hardware such as the element described referring to FIG. 2.

The summarizing server 100 further includes a storage unit 308, which is implemented by the storage device such as the HD 204 that operates with the HDD controller 205.

The communication unit 301 connects the summarizing server 100 to the communication network 2 using, for example, the network I/F 208, to communicate with other apparatuses such as the terminal apparatus 110.

The acquisition unit 302 executes processing of acquiring the speech of the user. For example, the acquisition unit 302 acquires the user's speech (speech data), which is to be transmitted to the summarizing server 100 by the speech transmitter 313 of the terminal apparatus 110.

The conversion unit 303 converts the speech acquired by the acquisition unit 302 into a plurality of texts. The process of converting speech into a plurality of texts may be referred to as, for example, transcription or texting. The conversion unit 303 may be implemented by, for example, a conversion server, a transcription server, or a text conversion server.

The determination unit 304 determines whether the plurality of texts converted by the conversion unit 303 satisfies a predetermined summarizing execution condition. In one example, the determination unit 304 determines whether the amount (size) of the texts converted by the conversion unit 303 reached a first threshold value (an example of the summarizing execution condition). In another example, the determination unit 304 determines whether the similarity calculated from the plurality of texts converted by the conversion unit 303 is lower than a second threshold value (another example of the summarizing execution condition). The determination unit 304 may be implemented by a summary trigger server that determines whether a plurality of texts satisfy a predetermined summarizing execution condition.

When the determination unit 304 determines that the plurality of texts converted by the conversion unit 303 satisfies the predetermined summarizing execution condition, the generation unit 305 generates a summary obtained by summarizing the plurality of texts satisfying the condition. In the present embodiment, the generation unit 305 may generate the summary using any desired technique. For example, the generation unit 305 may generate a summary sentence by summarizing a plurality of texts using the known cloud service that summarizes sentences using natural language processing, artificial intelligence (AI), etc. The generation unit 305 may be implemented by the summarizing server that summarizes the sentences.

The summarizing system 1 may further include a queuing server that queues a plurality of texts to be input to the generation unit 305. Alternatively, the generation unit 305 may have the function of the queuing server.

The providing unit 306 provides the summary generated by the generation unit 305 to the user. For example, the providing unit 306 transmits the summary generated by the generation unit 305 to the terminal apparatus 110 used by the user. Preferably, the providing unit 306 transmits, in addition to the summary generated by the generation unit 305, a plurality of texts used by the generation unit 305 to generate the summary to the terminal apparatus 110 used by the user. The providing unit 306 may be implemented by, for example, a Pub/Sub server that provides a Publish/Subscribe messaging service.

The DB 307 is, for example, a database that stores the plurality of texts converted by the conversion unit 303, the summary generated by the generation unit 305, conversation information, etc.

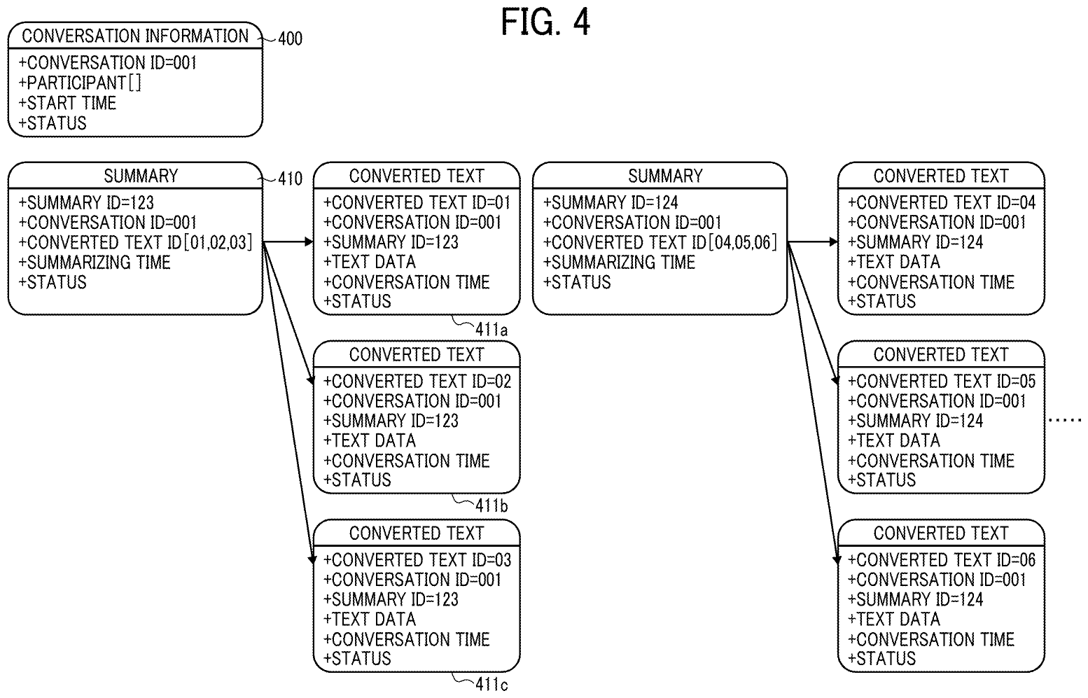

FIG. 4 is a diagram illustrating an example data structure of data managed by the summarizing system. The summarizing system 1 manages various data including, for example, conversation information 400, a summary 410, and converted texts 411a, 411b, and 411c, as illustrated in FIG. 4. In the following description, the “converted text 411” is used to indicate any one of the converted texts 411a, 411b, and 411c.

As illustrated in FIG. 4, the conversation information 400, the summary 410, and the converted text 411 each include a “conversation ID” for identifying a particular conversation. With the “conversation ID”, the summarizing system 1 can determine which conversation each data is related to. The summarizing system 1 generates the summary 410 and the converted text 411 for each “conversation ID”.

As illustrated in FIG. 4, the summary 410 and the converted text 411 each have a “summary ID” for identifying the summary. With the “summary ID”, the summarizing system 1 can determine which summary 410 each converted text 411 is related to. For example, when the converted text 411 is changed by the user, the summarizing system 1 can identify the summary 410 generated from the changed converted text 411 using the “summary ID”.

The summary 410 has an attribute “status”. With the “status”, the summarizing system 1 can determine whether the summary 410 is being generated, is completed for generation, or has been changed by the user input. The summarizing system 1 may provide the status of the summary to the application activated by the terminal apparatus 110.

Further, the conversation information 400, the summary 410, and the converted text 411 each include various other information as illustrated in FIG. 4. For example, the conversation information 400 includes information on the participant, and the conversation start time. The converted text 411 includes the conversation time when the speech is converted.

The storage unit 308 stores, for example, various types of information (threshold values, setting values, etc.), data, and programs, which are managed by the summarizing system 1.

In the example of FIG. 3, the conference server 10 is a general-purpose cloud service that provides a web conference service, and the description thereof will be omitted.

### Processing

In the following, example processing of assisting communication is described.

### Summarizing Processing

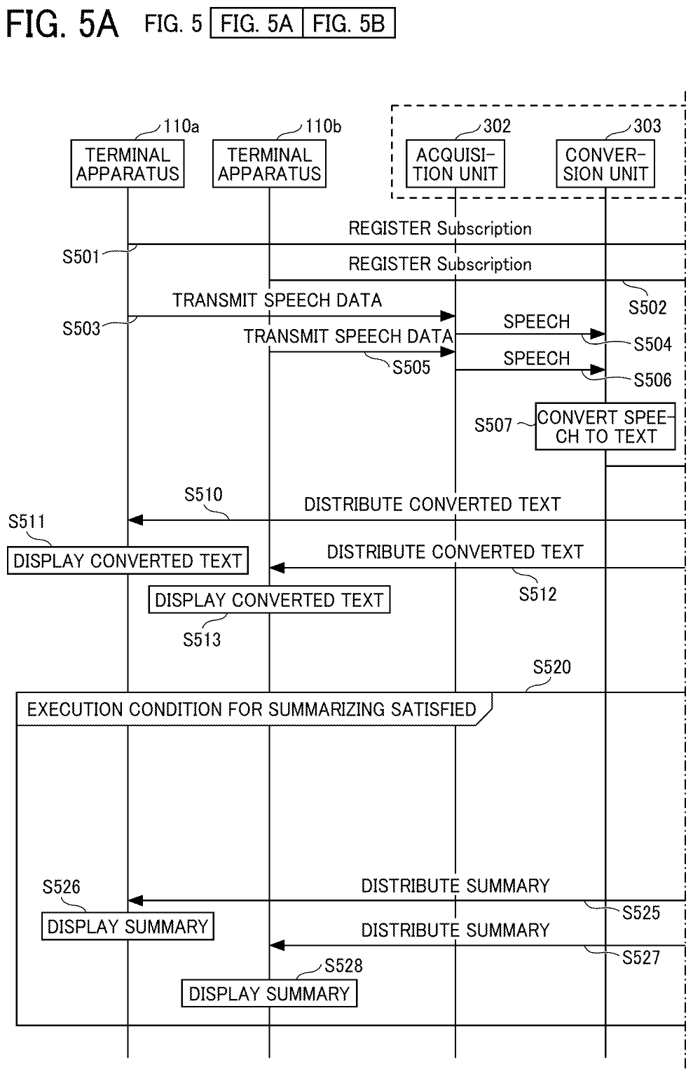

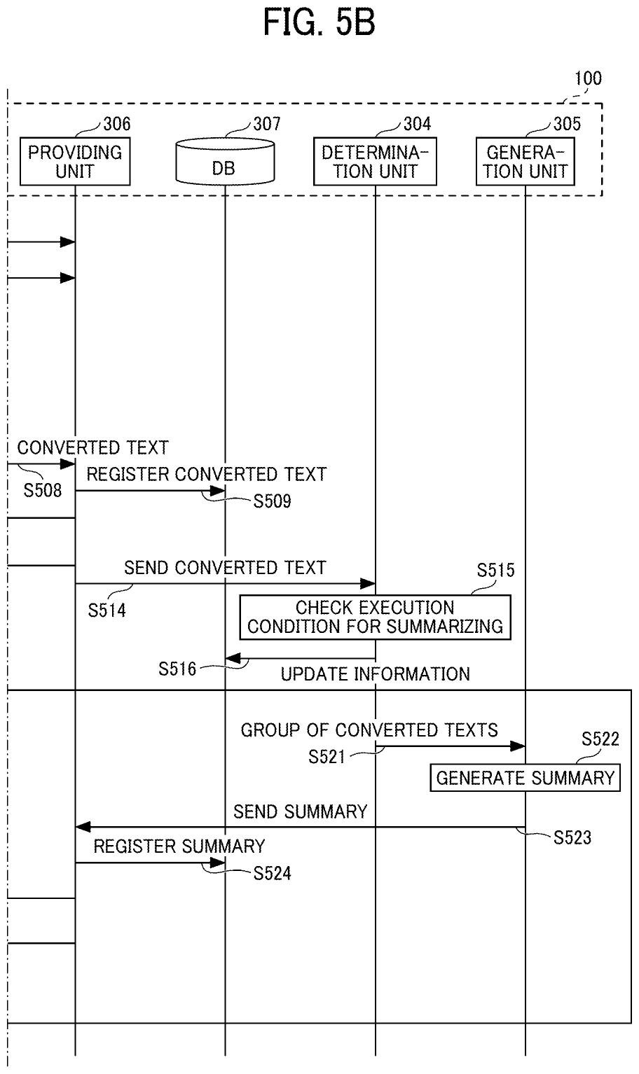

FIGS. 5A and 5B (FIG. 5) are a sequence diagram illustrating example processing of summarizing. At the start of the processing illustrated in FIG. 5, it is assumed that the terminal apparatuses 110a and 110b are participating in a conference (web conference) in which content data including speech data is transmitted and received via the conference server 10.

At S501 and S502, the terminal apparatuses 110a and 110b each register Subscription in the providing unit 306 that provides the Pub/Sub messaging service. Through Subscription registration, the terminal apparatuses 110a and 110b each establish two-way communication with the providing unit 306, and can receive notifications from the providing unit 306 without delay. Alternatively, the terminal apparatuses 110a and 110b may acquire information from the providing unit 306 by another method such as polling.

At S503, the speech transmitter 313 of the terminal apparatus 110a converts the speech acquired by the microphone 221 into speech data, and transmits the speech data to the summarizing server 100. In response to transmission of the speech data, at S504, the acquisition unit 302 of the summarizing server 100 receives the speech data transmitted by the terminal apparatus 110a, and outputs the received speech data to the conversion unit 303.

Similarly, at S505, the speech transmitter 313 of the terminal apparatus 110b converts the speech acquired by the microphone 221 into speech data, and transmits the speech data to the summarizing server 100. In response to transmission of the speech data, at S506, the acquisition unit 302 of the summarizing server 100 receives the speech data transmitted by the terminal apparatus 110b, and outputs the received speech data to the conversion unit 303.

At S507, the conversion unit 303 of the summarizing server 100 converts the speech data acquired by the acquisition unit 302 into text data. At S508, the conversion unit 303 sends the converted text data (hereinafter, referred to as the converted text) to the providing unit 306.

At S509, the providing unit 306 registers the converted text sent from the conversion unit 303 in the DB 307, for example, in a data structure as illustrated in FIG. 4.

At S510, the providing unit 306 distributes the converted text sent from the conversion unit 303 to the terminal apparatus 110a. At S511, the display controller 314 of the terminal apparatus 110a displays the distributed converted text on a display screen.

Similarly, at S512, the providing unit 306 distributes the converted text sent from the conversion unit 303 to the terminal apparatus 110b. At S513, the display controller 314 of the terminal apparatus 110b displays the distributed converted text on a display screen. An example of the display screen displayed by the terminal apparatus 110 will be described below.

At S514, the providing unit 306 distributes the converted text sent from the conversion unit 303 to the determination unit 304. At S515, the determination unit 304 checks the summarizing execution condition. Specifically, the determination unit 304 determines whether the converted text (a plurality of texts) converted by the conversion unit 303 satisfies the predetermined summarizing execution condition.

At S516, the determination unit 304 updates the information on the converted text registered in the DB 307. For example, the determination unit 304 assigns a converted text ID to the registered converted text.

The summarizing system 1 repeatedly executes the processing of steps S503 to S516, for example, while the conference is being held. At the summarizing system 1, when the determination unit 304 determines that the summarizing execution condition is satisfied at S515, the processing of S520 including S521 to S528 is executed.

At S521, when the determination unit 504 determines that the summarizing execution condition is satisfied, the providing unit 306 sends, to the generation unit 305, the plurality of converted texts (hereinafter, referred to as a converted text group). The converted text group includes a plurality of converted texts previously sent from the providing unit 306 after the determination unit 504 determines that the summarizing execution condition is satisfied.

At S522, the generation unit 305 summarizes the converted text group (a plurality of texts) sent from the determination unit 304, and generates a summary. At S523, the generation unit 305 sends the generated summary to the providing unit 306.

At S524, the providing unit 306 registers the summary sent from the generation unit 305 in the DB 307, for example, in the data structure as illustrated in FIG. 4. For example, as illustrated in FIG. 4, the providing unit 306 registers the summary 410 and the converted texts 411a, 411b, and 411c used to generate the summary 410 so that they have the same summary IDs.

At S525, the providing unit 306 distributes the summary sent from the generation unit 305 to the terminal apparatus 110a. At S526, the display controller 314 of the terminal apparatus 110a displays the distributed summary on the display screen.

At S527, the providing unit 306 distributes the summary sent from the generation unit 305 to the terminal apparatus 110b. At S528, the display controller 314 of the terminal apparatus 110b displays the distributed summary on the display screen.

### Example 1 of Display Screen

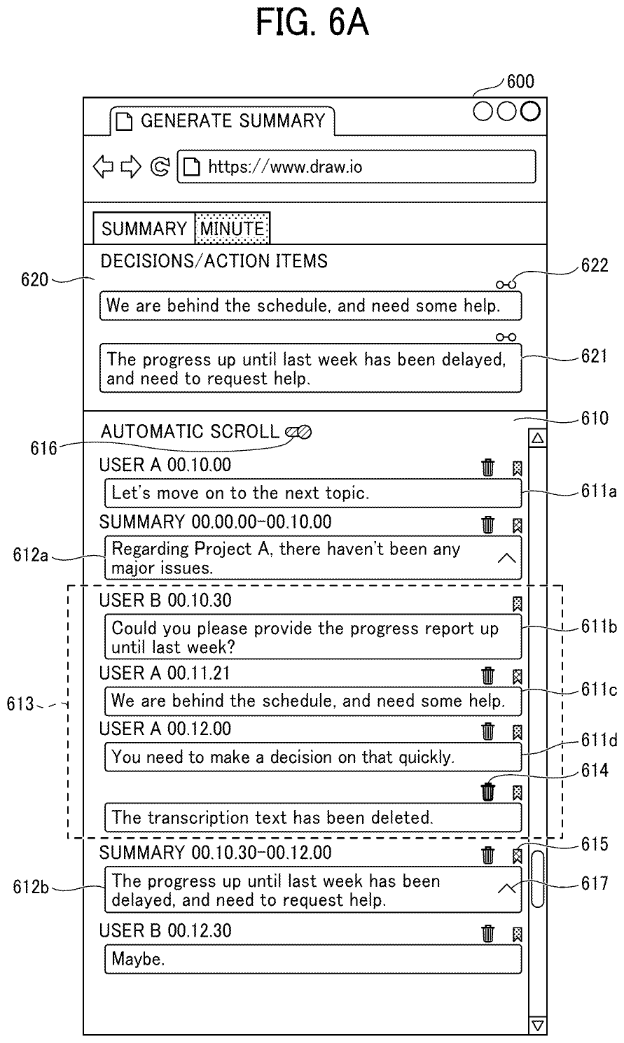

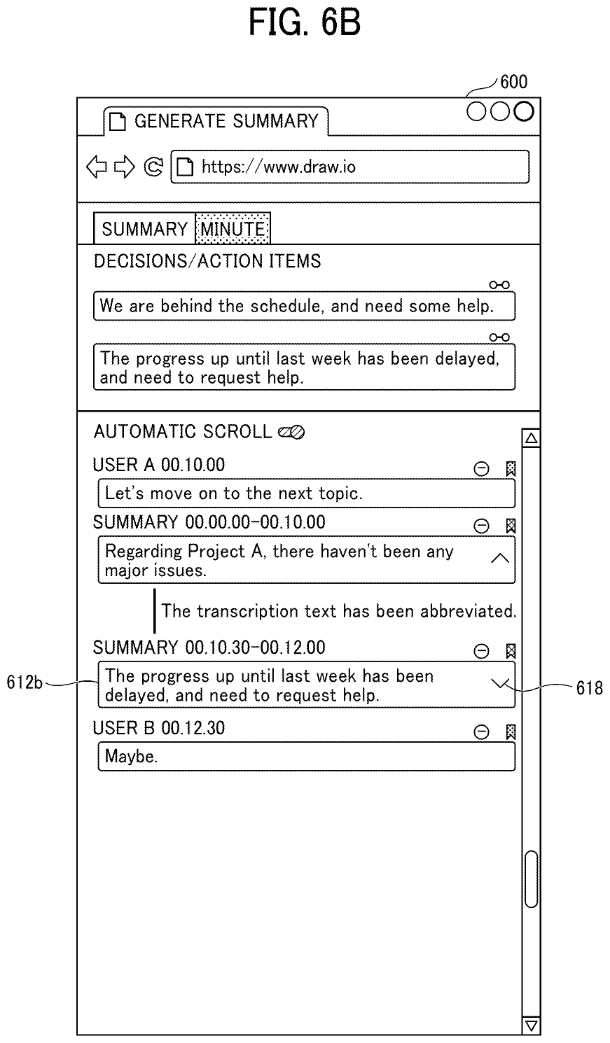

FIGS. 6A and 6B are diagrams each illustrating an example display screen, displayed at the terminal apparatus. FIG. 6A illustrates an example display screen 600 of the application, including the converted text and the summary sent from the summarizing server 100, which is displayed by the display controller 314 of the terminal apparatus 110.

In the example of FIG. 6A the display screen 600 includes a first display area 610 that displays the converted text (the transcribed text) and the summary, and a second display area 620 that displays decisions and action items. The second display area 620 is optional such that it does not have to be displayed.

The display controller 314 sequentially displays the converted texts 611a, 611b, 611c, and 611d distributed from the summarizing server 1 in the first display area 610 in the order of reception. Similarly, the display controller 314 sequentially displays the summaries 612a and 612b distributed from the summarizing server 1 in the first display area 610 in the order of reception. Thus, for example, as illustrated in FIG. 6A or 6B, the display controller 314 can display the summary 612b and the plurality of converted texts 613 used to generate the summary 612b in the first display area 610 in association with each other.

In the following description, the “converted text 611” is used to indicate any one of the converted texts 611a, 611b, 611c, and 611d. The “summary 612” is used to indicate any one of the summaries 612a and 612b.

Preferably, the converted text 611 displayed in the first display area 610 is provided with a delete icon 614 for deleting the converted text 611. The user can delete the converted text 611 corresponding to the delete icon 614 by selecting the delete icon 614. Similarly, the summary 612 is provided with a delete icon 614 for deleting the summary 612.

Preferably, the summary 612 displayed in the first display area 610 is provided with a bookmark icon 615 for displaying the summary 612 in the second display area 620.

The user can display a copy of the summary 612 corresponding to the bookmark icon 615 in the second display area by selecting the bookmark icon 615. Similarly, the converted text 611 is provided with a bookmark icon 615 for displaying the converted text 611 in the second display area 620.

Preferably, the first display area 610 includes an “automatic scroll” button 616 for setting whether or not to automatically scroll the converted text 611 and the summary 612. For example, the user can set the automatic scroll function to be invalid by turning off the “automatic scroll” button 616.

Preferably, the summary 612 is provided with a hide button 617 for hiding the converted text 611 used to generate the summary. For example, as illustrated in FIG. 6B, the user can hide the plurality of converted texts 613 used for generating the summary 612b by selecting the hide button 617 of the summary 612b.

As illustrated in FIG. 6B, when the plurality of converted texts 613 used for generating the summary 612b are not displayed, the summary 612b is provided with a display button 618 for displaying the converted texts 613 used for generating the summary 612b. The user can display the converted texts 613 used for generating the summary 612b again as illustrated in FIG. 6A by selecting the display button 618.

Preferably, when the text 621 displayed in the second display area 620 is edited, the display controller 314 reflects the edited content in the converted text 611 or the summary 612 of the copy source. The text displayed in the second display area 620 is provided with a jump button 622 for jumping to the converted text 611 or the summary 612 from which the text is copied.

### Example 2 of Display Screen

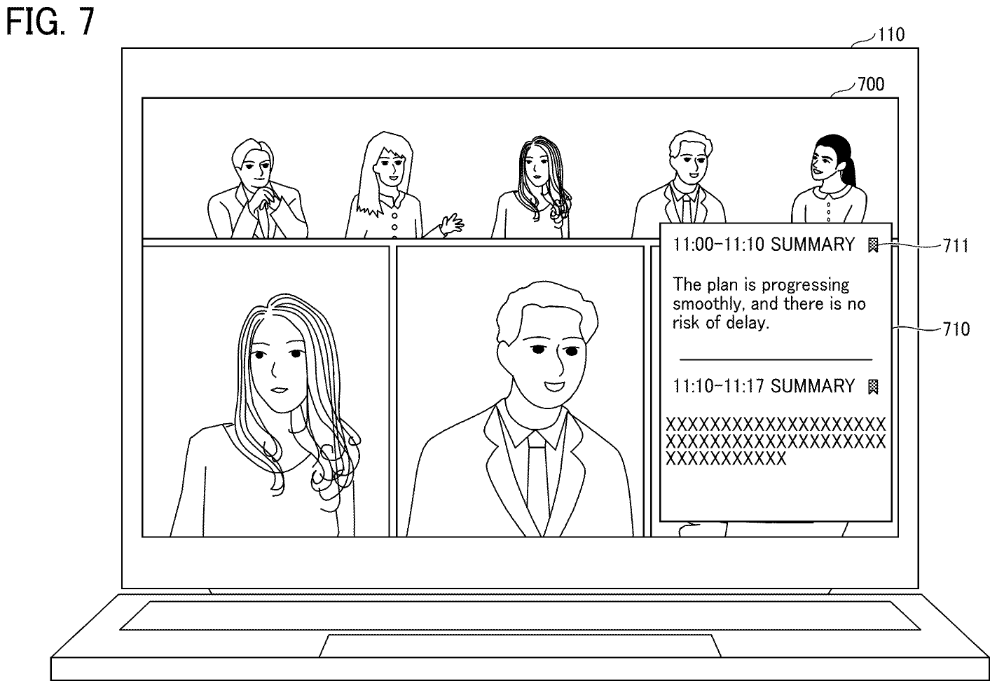

FIG. 7 is a diagram illustrating an example display screen, displayed at the terminal apparatus. When the terminal apparatus 110 carries out a conference (web conference) with another terminal apparatus 110, the terminal apparatus 110 often displays a conference screen, which displays a conference video captured by another terminal apparatus 110, presentation materials, etc. It may be sometimes difficult to display the display screen 600 described with reference to FIG. 6A or 6B on a display unit such as the display 206 of the terminal apparatus 110, for example, due to the display size.

As illustrated in FIG. 7, the display controller 314 of the terminal apparatus 110 may display a display screen 710, which displays the summary on a conference screen 700 displayed on the display 206 of the terminal apparatus 110, in the form of a window being superimposed on the conference screen 700. In the example of FIG. 7, the display controller 314 displays the display screen 710 that displays the two most recent summaries, on top of the conference screen 700. The number of summaries displayed on the display screen 710 may be one, or three or more.

The summary displayed on the display screen 710 is provided with a bookmark icon 711 for displaying the summary in the second display area 620, as in the case of the summary 612 described with reference to FIG. 6A or 6B. The user can display a copy of the summary corresponding to the bookmark icon 711 in the second display area 620 of the display screen 600 operating in the background by selecting the bookmark icon 711.

### Example 3 of Display Screen

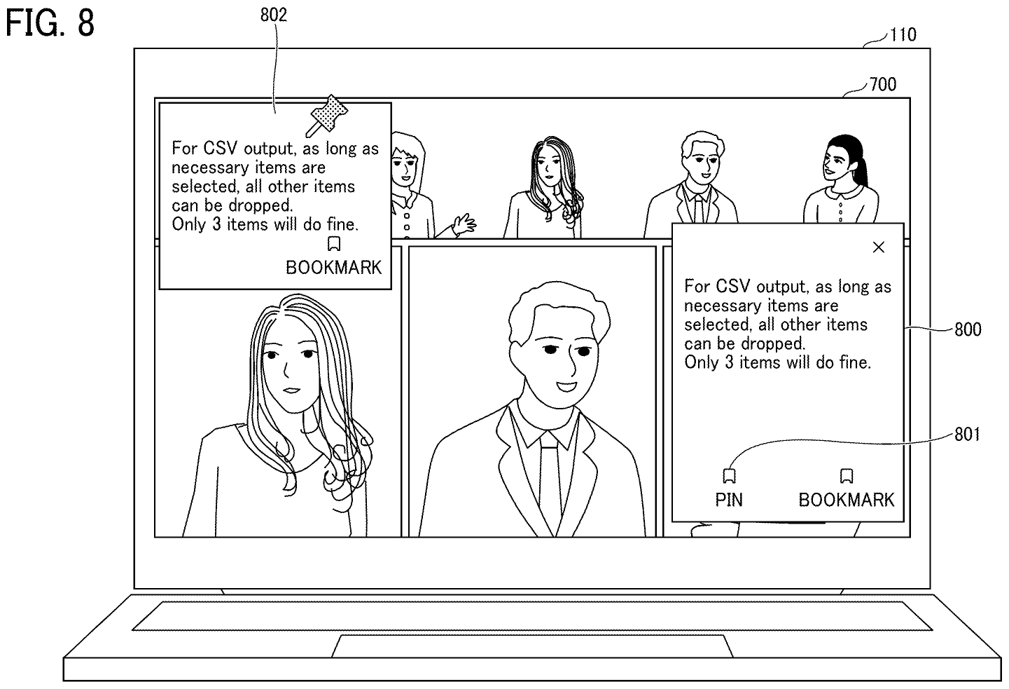

FIG. 8 is a diagram illustrating an example display screen, displayed at the terminal apparatus. In the example of FIG. 8, the display controller 314 of the terminal apparatus 110 displays a display screen 800 that displays the summary, which is superimposed on the conference screen 700 displayed on the display 206 of the terminal apparatus 110. In this case, when a new summary is displayed on the display screen 800, the summary currently displayed on the display screen 800 disappears.

In the example of FIG. 8, the display screen 800 has a pinning icon 801 for pinning the summary on the screen. By selecting the pinning icon 801, the user can keep displaying (i.e., pinning) the copy 802 of the summary, currently displayed on the display screen 800, on the display 206 of the terminal apparatus 110.

### Determination Processing

### First Example

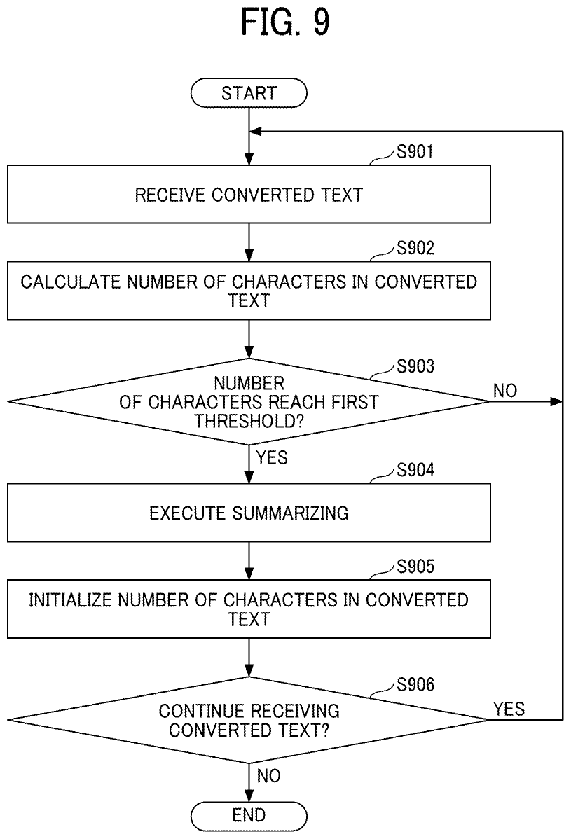

FIG. 9 is a flowchart illustrating example processing of determining, according to the first example. The processing of FIG. 9 is an example determination processing, in which the determination unit 304 of the summarizing server 100 determines whether the converted text converted by the conversion unit 303 satisfies a predetermined summarizing execution condition at S515 of FIG. 5.

In response to reception of a converted text from the providing unit 306 at S901, the determination unit 304 performs S902 and the subsequent steps.

At S902, the determination unit 304 calculates a number of characters in the converted text received from the providing unit 306.

At S903, the determination unit 304 determines whether the calculated number of received characters reached a first threshold value. It is assumed that the first threshold value is previously set to a number of characters to be summarized. When the number of received characters has not reached the first threshold value (“NO” at S903), the determination unit 304 returns the operation to S901. When the number of received characters has reached the first threshold value (“YES” at S903), the determination unit 304 proceeds the operation to S904.

At S904, the determination unit 304 causes the generation unit 305 to execute summarizing.

For example, the determination unit 304 sends, to the generation unit 305, the converted text group received from the providing unit 306.

At S905, the determination unit 304 initializes the number of received characters for the converted text.

At S906, the determination unit 304 determines whether to continue reception of the converted text. When the reception of the converted text is continued (“YES” at S906), the determination unit 304 returns the operation to S901. On the other hand, when the reception of the converted text is not continued (“NO” at S906), the determination unit 304 ends the processing.

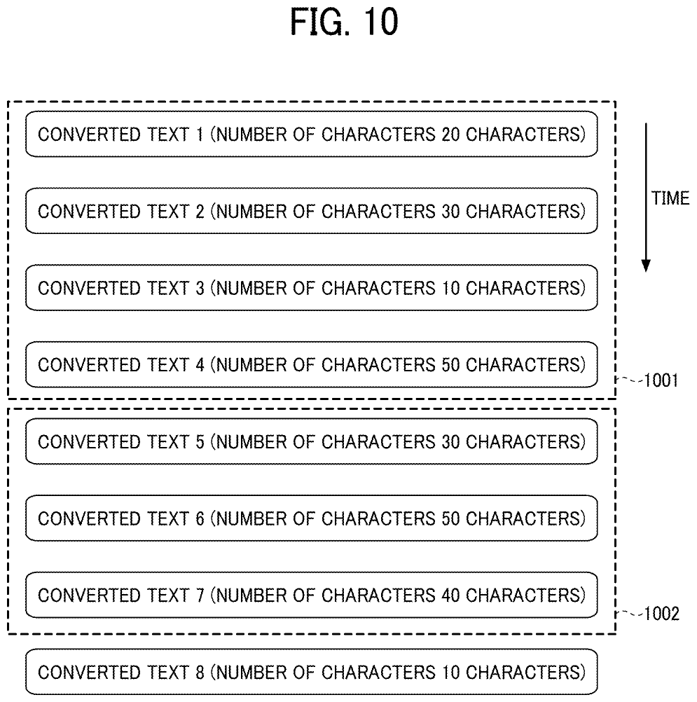

FIG. 10 is a diagram for explaining the determination processing according to the first example. For example, the determination unit 304 sequentially receives the converted texts 1 to 8 as illustrated in FIG. 10 from the providing unit 306. In this example, the first threshold value is set to 100 characters.

When the determination unit 304 receives the converted text 4, as the number of characters of the converted text reached 100 characters through the processing of FIG. 9, the determination unit 304 sends the converted texts 1 to 4 to the generation unit 305 as the converted text group 1001. The generation unit 305 generates a summary obtained by summarizing the converted text group 1001.

Subsequently, when the determination unit 304 receives the converted texts 5 to 7 after resetting, as the number of characters of the converted text reached 100 characters, the determination unit 304 sends the converted texts 5 to 7 to the generation unit 305 as the converted text group 1002.

As described above, by setting the number of characters of the converted text to the threshold value, an amount of conversation to be summarized can be adjusted. The first threshold value (the number of characters to be summarized) may be set by the user.

### Second Example

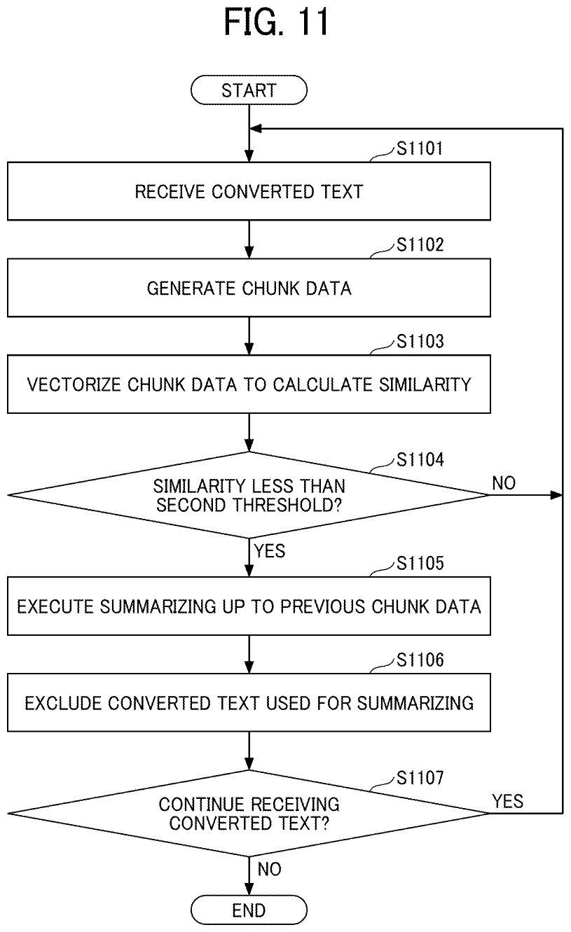

FIG. 11 is a flowchart illustrating example processing of determining, according to the second example. The processing of FIG. 11 is another example determination processing, in which the determination unit 304 of the summarizing server 100 determines whether the converted text converted by the conversion unit 303 satisfies a predetermined summarizing execution condition at S515 of FIG. 5.

In response to reception of a converted text from the providing unit 306 at S1101, the determination unit 304 performs S1102 and the subsequent steps.

At S1102, the determination unit 304 combines the plurality of converted texts received from the providing unit 306 to generate chunk data. Since processing of only one converted text is meaningless, a plurality of converted texts are collected as chunk data to be subject to the determination processing.

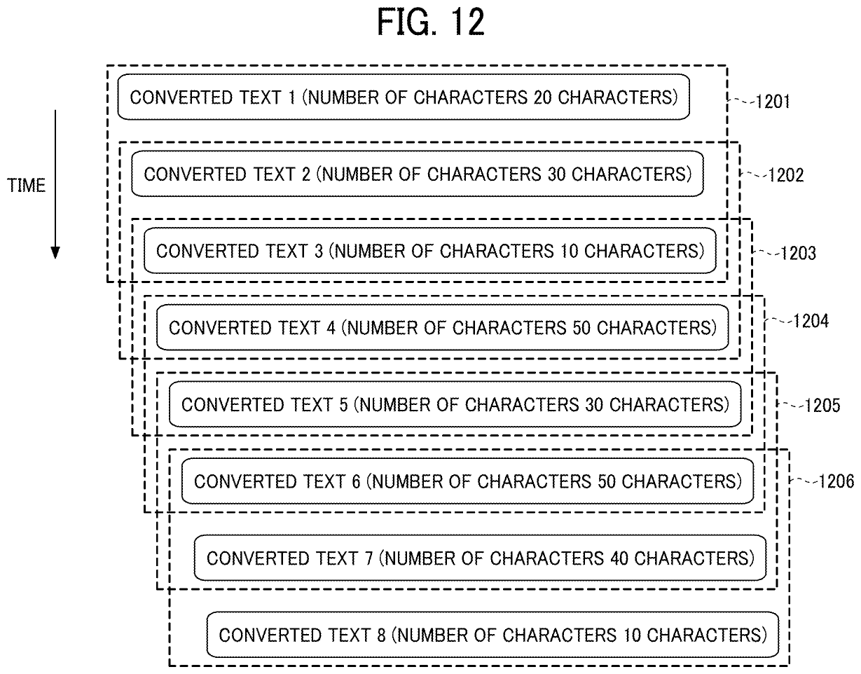

FIG. 12 is a diagram for explaining the determination processing according to the second example. For example, the determination unit 304 sequentially receives the converted texts 1 to 8 as illustrated in FIG. 12 from the providing unit 306. In the example of FIG. 12, the determination unit 304 sets three (an example of a predetermined number) converted texts, which are received most recently, as one chunk data. For example, the determination unit 304 sets the converted texts 1 to 3 as chunk data 1201 when the converted text 3 is received, and sets the converted texts 2 to 4 as chunk data 1202 when the converted text 4 is received. Similarly, the determination unit 304 sets the converted texts 3 to 5 as chunk data 1203 when the converted text 5 is received, and sets the converted texts 4 to 6 as chunk data 1204 when the converted text 6 is received.

In this way, the determination unit 304 may set the predetermined number of converted texts that are received most recently as one chunk data. In another example, when the number of characters of the plurality of received converted texts reaches a predetermined number of characters, the determination unit 304 may set the plurality of received converted texts as one chunk data.

When creating chunk data, the determination unit 304 may simply combine a plurality of converted texts into the chunk data, or may input a plurality of converted texts to the generation unit 305 to summarize.

At S1103 of FIG. 11, the determination unit 304 vectorizes the generated chunk data to calculate the similarity. For example, the determination unit 304 calculates the similarity between the generated chunk data and the chunk data generated last time. For example, in FIG. 12, when the converted text 4 is received and the chunk data 1202 is created, the determination unit 304 calculates the similarity between the chunk data 1202 and the chunk data 1201.

As a method of vectorizing chunk data, for example, chunk data is divided into words, and a vector value is calculated from the divided words. As a method of calculating the vector value, for example, any known natural language process such as Bag of Words or BERT (Bidirectional Encoder Representations from Transformers) may be applied.

At S1104 of FIG. 11, the determination unit 304 determines whether the calculated similarity is less than a second threshold value. It is assumed that the second threshold value is previously set to a value indicating that the similarity between chunk data is low. When the similarity is not less than the second threshold value (“NO” at S1104), the determination unit 304 returns the processing to S1101. When the similarity is less than the second threshold value (“YES” at S1104), the determination unit 304 proceeds the processing to S1105.

At S1105, the determination unit 304 executes summarizing processing up to the previous chunk data. For example, in FIG. 12, when the converted text 4 is received, if the similarity is lower than the second threshold value, the determination unit 304 sends the converted texts 1 to 3 to the generation unit 305 as a converted text group. Similarly, when the converted text 7 is received, if the similarity is lower than the second threshold value, the determination unit 304 sends the converted texts 1 to 6 to the generation unit 305 as a converted text group.

At S1106, the determination unit 304 determines that the converted text used for summarizing, has been summarized, and excludes such converted text from the subject to summarizing.

At S1107, the determination unit 304 determines whether to continue reception of the converted text. When the reception of the converted text is continued (“YES” at S1107), the determination unit 304 returns the processing to S1101. On the other hand, when the reception of the converted text is not continued (“NO” at S1107), the determination unit 304 ends the processing.

At S1104 of FIG. 11, the determination unit 304 simply compares the calculated similarity with the second threshold value, but this is merely an example. For example, any other value, such as a moving average of the calculated similarity or a differential value of the calculated similarity may be compared with the second threshold value.

### Processing to Change

For example, it is desired that the user can edit the summary 612 on the display screen 600 described with reference to FIG. 6A or 6B. This allows the user to easily modify the summary 612 if the user feels uncomfortable with the summary 612.

Further, it is desired that contents of editing on the display screen 600 displayed by the terminal apparatus 110a, the contents of selection of the bookmark icon 615, etc. are reflected on the display screen 600 displayed by another terminal apparatus 110b.

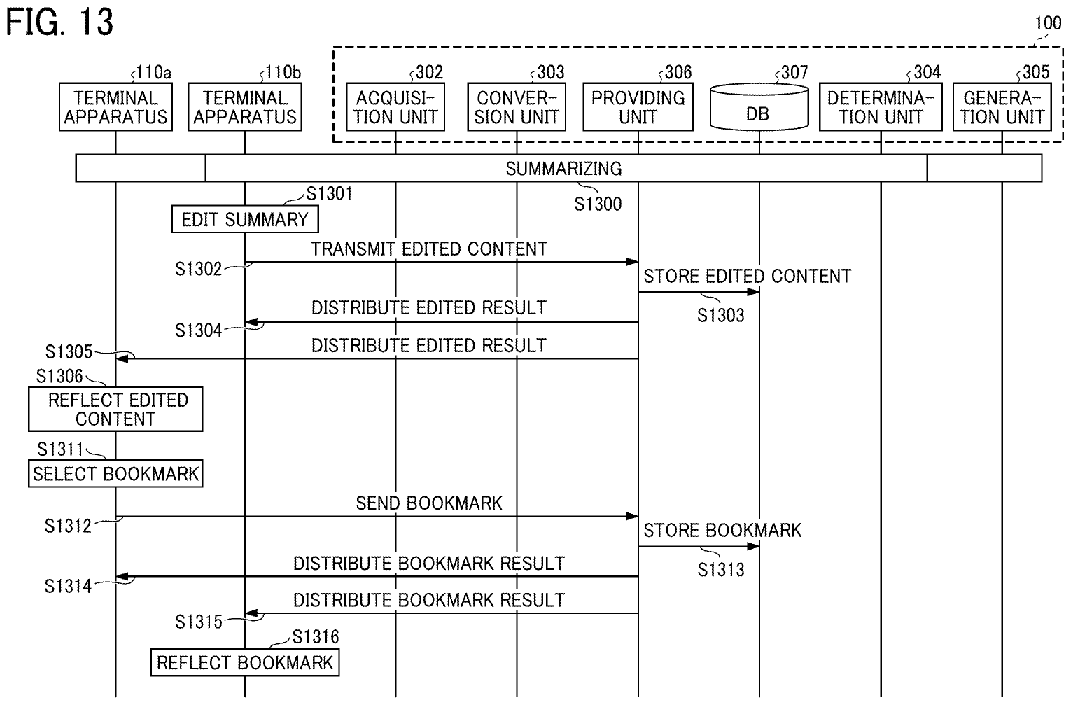

FIG. 13 is a sequence diagram illustrating example processing of changing the summary. At S1300, the summarizing system 1 executes the summarizing processing described with reference to FIG. 5, and the terminal apparatuses 110a and 110b each display the display screen 600 as illustrated in FIG. 6A or 6B.

At S1301 and S1302, in response to editing of the summary 612 by the user, the terminal apparatus 110b transmits the edited content to the providing unit 306 of the summarizing server 100. In response to this, at S1303, the providing unit 306 stores the edited content received from the terminal apparatus 110b in the DB 307.

At S1304 and S1305, the providing unit 306 distributes the editing result to the terminal apparatuses 110a and 110b. At S1306, the edited content of the summary received at the terminal apparatus 110b is reflected on the display screen 600 of the terminal apparatus 110a.

At S1311 and S1312, when the bookmark icon 615 (FIG. 6A) is selected by the user, the terminal apparatus 110a transmits bookmark information to the providing unit 306 of the summarizing server 100. At S1313, the providing unit 306 stores the bookmark information received from the terminal apparatus 110a in the DB 307.

At S1314 and S1315, the providing unit 306 distributes the bookmark result to the terminal apparatuses 110a and 110b. Accordingly, at S1316, the selection of the bookmark icon 615 at the terminal apparatus 110a is reflected on the display screen 600 of the terminal apparatus 110b.

### Re-Summarizing Processing 1

It is desired that the user can edit the converted text 611 on the display screen 600 described with reference to FIGS. 6A and 6B. When the converted text 611 is edited, the summarizing system 1 preferably re-generates the summary 612.

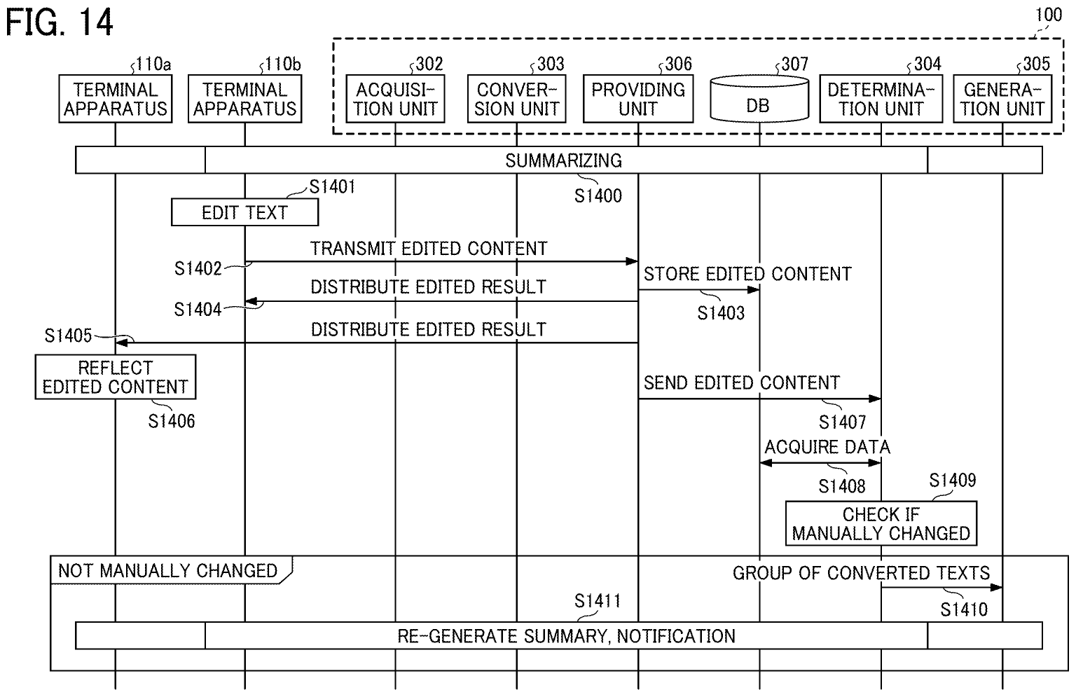

FIG. 14 is a sequence diagram illustrating example processing of re-summarizing. The processing of FIG. 14 is an example of re-summarizing processing executed by the summarizing system 1.

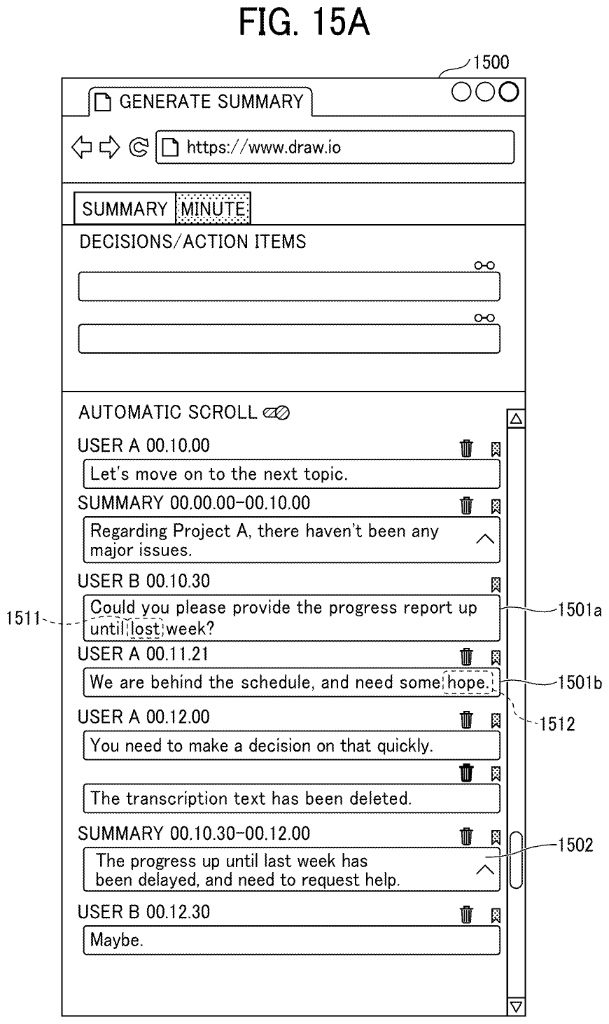

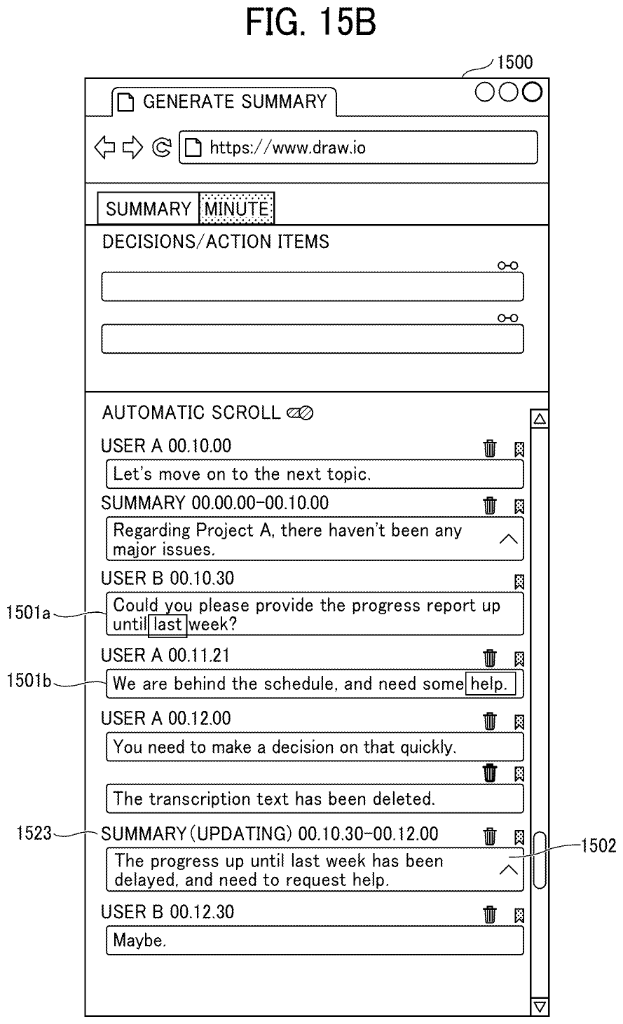

At S1400, the summarizing system 1 executes the summarizing processing described with reference to FIG. 5, and the terminal apparatuses 110a and 110b each display the display screen 1500 as illustrated in FIG. 15A. In the example of FIG. 15A, the conversion texts 1501a and 1501b may include errors (conversion errors, for example), and the summary 1502 thus includes an error due to the errors in the conversion texts 1501a and 1501b.

At S1401 and S1402, when the user edits (corrects) the converted texts 1501a and 1501b, the terminal apparatus 110b transmits the edited contents to the providing unit 306 of the summarizing server 100. In response to this, at S1403, the providing unit 306 stores the edited contents received from the terminal apparatus 110b in the DB 307.

At S1404 and S1405, the providing unit 306 distributes the editing result to the terminal apparatuses 110a and 110b. At S1406, the edited contents of the converted text input at the terminal apparatus 110b are reflected on the display screen 1500 of the terminal apparatus 110a. Accordingly, as illustrated in FIG. 15B, the corrected converted texts 1501a and 1501b are reflected both on the display screens 1500 displayed by the terminal apparatuses 110a and 110b.

At S1407, the providing unit 306 sends the change, which is the edited contents, received from the terminal apparatus 110b to the determining unit 304. In response to this, at S1408, the determination unit 304 acquires data related to the received edited contents from the DB 307. For example, the determination unit 304 acquires the converted text and the summary having the same summary ID as the edited converted text.

At S1408, the determination unit 304 checks whether or not the acquired summary has been changed by a user input (referred to as “manually changed”). When the acquired summary has not been changed by a user input, the summarizing system 1 executes the processing of S1410 and S1411. When the acquired summary has been changed by a user input, the summarizing system 1 stops execution (does not execute) of S1410 and S1411. This prevents the summarizing system 1 from overwriting the summary that has been corrected by the user.

At S1410, the determination unit 304 sends the converted text group acquired at S1408 to the generation unit 305. At S1411, the summarizing system 1 performs processing to re-generate the summary and distribute the summary. For example, the summarizing system 1 re-executes the summarizing processing and the distributing processing, similarly to S522 to S528 of FIG. 5, using the converted text group sent to the generation unit 305 by the determination unit 304.

Preferably, while S1411 is being performed, the terminal apparatuses 110a and 110b display information 1523 indicating that the summary 1502 is being re-generated on the display screen 1500, as illustrated in FIG. 15B. For example, the information 1523 includes a phrase “updating”, which indicates re-summarizing is taking place.

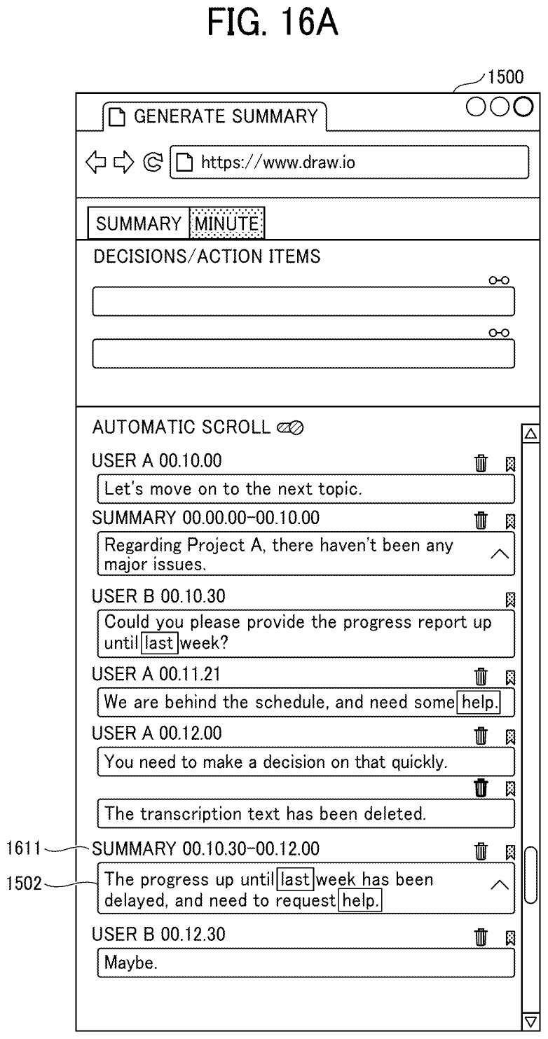

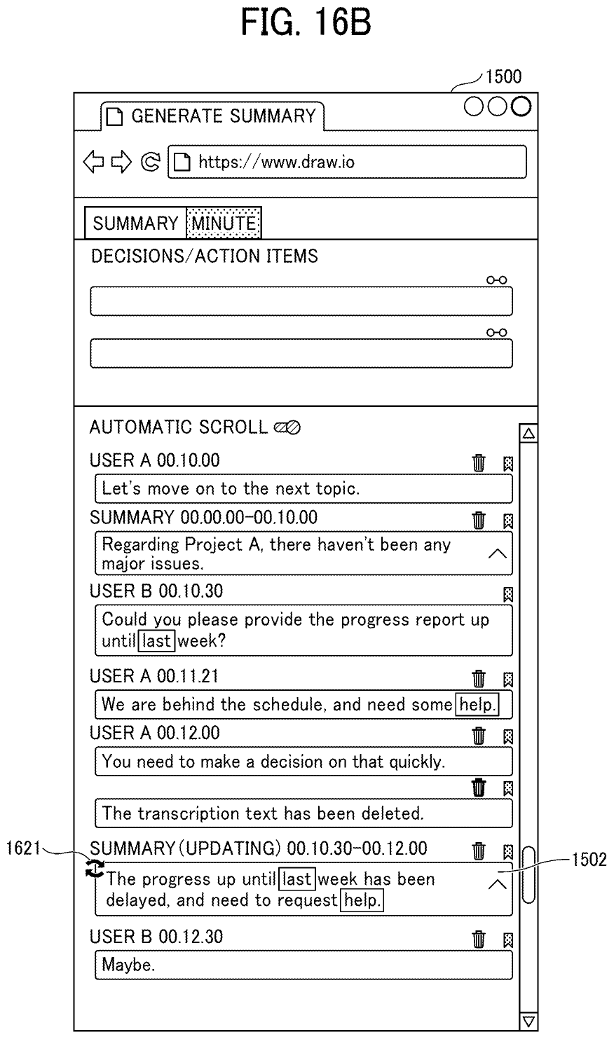

Through the processing of FIG. 14, as illustrated in FIG. 16A, the summary 1502 is re-generated. When the re-summarizing processing is completed, the terminal apparatuses 110a and 110b returns to the previously display, for example, by hiding the information 1523 indicating that the re-summarization is taking place.

### Modification

In the example of FIG. 14, the summarizing system 1 automatically executes the processing of S1410 and S1411 when there is no manual change in the summary. In another example, as illustrated in FIG. 16B, the summarizing system 1 may display an update icon 1621 indicating that the summary 1502 can be re-generated, and may execute the processing of S1410 and S1411 when the update icon 1621 is selected.

### Re-Summarizing Processing 2

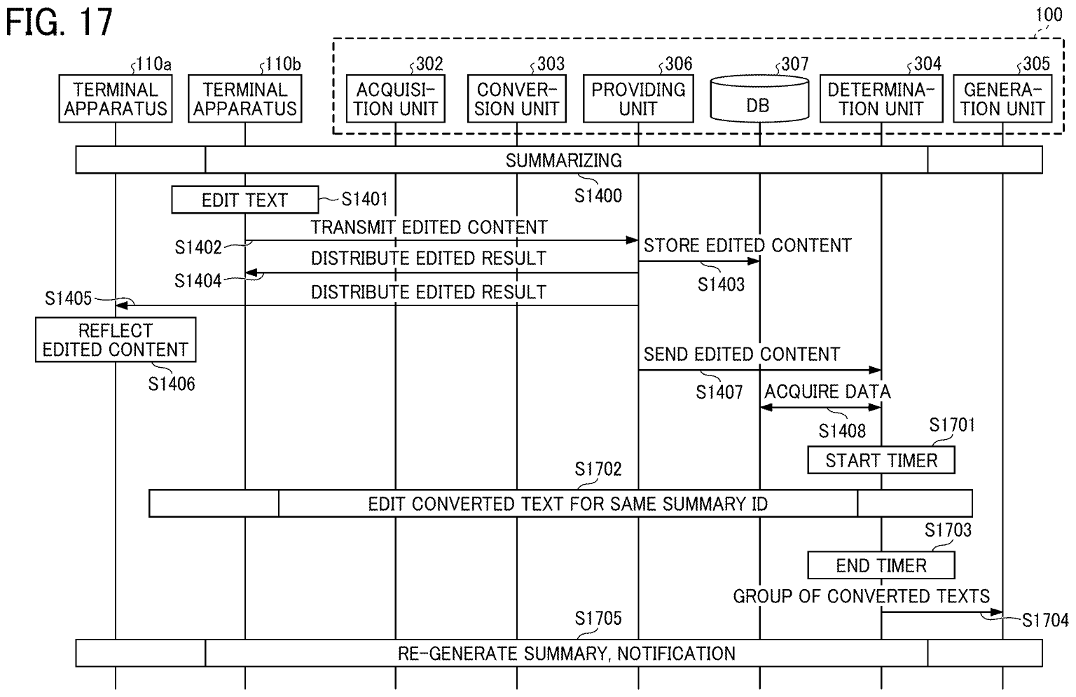

FIG. 17 is a sequence diagram illustrating example processing of re-summarizing. The processing of FIG. 17 is an example of re-summarizing processing executed by the summarizing system 1. The processing of S1400 to S1408 in FIG. 17 is the same as the processing of S1400 to S1408 illustrated in FIG. 14, and thus description thereof is omitted.

At S1701, the determination unit 304 starts a summary timer for measuring a first time period.

At S1702, even if the processing of editing the converted text as illustrated in S1401 to S1408 is performed on the converted text corresponding to the same summary ID, the determination unit 304 does not start the re-summarizing processing.

At S1703 and S1704, as the summary timer ends, the determination unit 304 sends the converted text group acquired at S1408 and subsequent steps to the generation unit 305. At S1705, the summarizing system 1 performs processing to re-generate the summary and send the notification. For example, the summarizing system 1 re-executes the summarizing processing and the notification processing, similarly to S522 to S528 of FIG. 5, using the converted text group sent to the generation unit 305 by the determination unit 304.

Through the processing of FIG. 17, the summarizing system 1 updates the summary 1502 after the first time period has elapsed since the plurality of converted texts 1501a and 1501b corresponding to the summary 1502 were changed for the first time. This can prevent the summary 1502 from being frequently updated while the user is correcting the converted texts 1501a and 1501b, for example.

### Re-Summarizing Processing 3

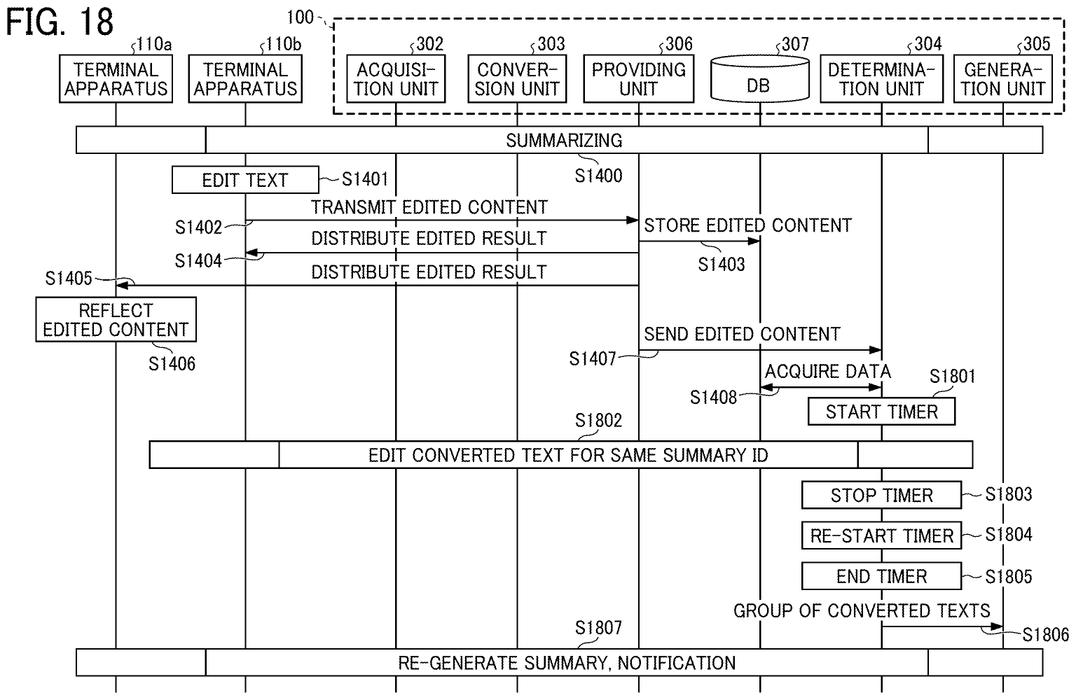

FIG. 18 is a sequence diagram illustrating example processing of re-summarizing. The processing of FIG. 17 is an example of re-summarizing processing executed by the summarizing system 1. The processing of S1400 to S1408 in FIG. 17 is the same as the processing of S1400 to S1408 illustrated in FIG. 14, and thus description thereof is omitted.

At S1801, the determination unit 304 starts a summary timer for measuring a second time period.

At S1802, if the processing of editing the converted text as illustrated in S1401 to S1408 is performed on the converted text corresponding to the same summary ID, the determination unit 304 executes the processing of S1803 and S1804.

At S1803, the determination unit 304 stops the summary timer, and at step S1804, starts the summary timer for measuring the second time period.

At S1805 and S1806, as the summary timer ends, the determination unit 304 sends the converted text group acquired at S1408 and subsequent steps to the generation unit 305.

At S1807, the summarizing system 1 performs processing to re-generate the summary and send the notification. For example, the summarizing system 1 re-executes the summarizing processing and the notification processing, similarly to S522 to S528 of FIG. 5, using the converted text group sent to the generation unit 305 by the determination unit 304.

Through the processing of FIG. 18, the summarizing system 1 updates the summary 1502 after the second time period has elapsed since the plurality of converted texts 1501a and 1501b corresponding to the summary 1502 were changed for the last time. Even when the user corrects the converted texts 1501a and 1501b in large amounts, it prevents the summary 1502 from being updated during the correction.

In the processing of FIGS. 17 and 18, as in the processing of FIG. 14, the processing of re-summarizing may be stopped in a case where the summary is changed by a user input.

As described above, with the summarizing system, the user can easily check the most recent summary.

Further, in the above-described examples, the summarizing system 1 may output the summary for provision to the user in various ways. For example, in addition or in alternative to display, the summary may be output as voice.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The apparatuses or devices described in one or more embodiments are just one example of plural computing environments that implement the one or more embodiments disclosed herein. In some embodiments, the summarizing server 100 includes plural computing devices, such as a server cluster. The multiple computing devices are configured to communicate with one another through any type of communication link, including a network, a shared memory, etc., and perform processes disclosed herein.

Further, the elements of the summarizing server 100 may be integrated into one server device or may be divided into a plurality of devices.

The present specification discloses a summarizing system, a summarizing method, and a program stored on a non-transitory recording medium.

### Aspect 1

The summarizing system includes: an acquisition unit that acquires speech; a conversion unit that converts the speech into a plurality of texts; a generation unit that generates a summary of the plurality of texts when the plurality of texts satisfy a summarizing execution condition; and a providing unit that provides the summary to the user.

### Aspect 2

In one example, the summarizing execution condition is a condition that an amount of the plurality of texts converted by the conversion unit reaches a first threshold value.

### Aspect 3

In another example, the summarization execution condition is a condition that a similarity calculated from the plurality of texts converted by the conversion unit is lower than a second threshold value.

### Aspect 4

In the summarizing system of Aspect 1, the summarizing system further includes a data management unit that manages the summary and the plurality of texts in association with each other. The generation unit updates the summary when the plurality of texts are changed at least partially.

### Aspect 5

In the summarizing system of any one of Aspects 1 to 4, the providing unit distributes the summary and the plurality of texts used for generating the summary to a terminal apparatus used by the user. The terminal apparatus includes a display controller that causes a display to display a display screen on which at least the summary is displayed.

### Aspect 6

In the summarizing system of Aspect 5, the display screen displays the plurality of texts used for generating the summary in association with the summary in a manner that are editable by the user.

### Aspect 7

In the summarizing system of Aspect 5, the display screen displays the summary in a manner that allows the user to extract, copy, or edit the summary.

### Aspect 8

In the summarizing system of Aspect 5, the speech is collected during a conference in which content data is transmitted or received between a plurality of terminal apparatuses including the terminal apparatus of the user. The display controller displays the display screen so as to be superimposed on a conference screen provided for the conference.

### Aspect 9

The summarizing system of Aspect 2 updates the summary, after a first time period has elapsed since the plurality of texts were changed at least partially for the first time or after a second time period has elapsed since the plurality of texts were changed at least partially for the last time.

### Aspect 10

In the summarizing system of Aspect 4, the summarizing system stops updating the summary in a case where the summary is being changed by a user input.

### Aspect 11

In the summarizing system of Aspect 4, the summary is updated after a predetermined operation by the user is received.

### Aspect 12

A summarizing method includes: acquiring speech; converting the speech into a plurality of texts; generating a summary of the plurality of texts when the plurality of texts satisfy a summarizing execution condition; and providing the summary to a user.

### Aspect 13

A program causes a computer to perform a summarizing method including: acquiring speech; converting the speech into a plurality of texts; generating a summary of the plurality of texts when the plurality of texts satisfy a summarizing execution condition; and providing the summary to a user.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A summarizing system comprising processing circuitry configured to:
acquire speech;
convert the speech into a plurality of texts;
generate a summary of the plurality of texts when the plurality of texts satisfy a summarizing execution condition; and
output the summary to a user.

2. The summarizing system of claim 1, wherein
the processing circuitry determines that the summarizing execution condition is satisfied when an amount of the plurality of texts that are converted reached a first threshold value.

3. The summarizing system of claim 1, wherein
the processing circuitry determines that the summarizing execution condition is satisfied when a similarity calculated from the plurality of texts that are converted is lower than a second threshold value.

4. The summarizing system of claim 1, further comprising:
a memory that stores the summary and the plurality of texts in association with each other,
wherein the processing circuitry is configured to update the summary when at least a part of the plurality of texts is changed.

5. The summarizing system of claim 1, wherein
the processing circuitry distributes the summary and the plurality of texts used for generating the summary to a terminal apparatus used by the user, and
display, on a display of the terminal apparatus, a display screen that displays at least the summary.

6. The summarizing system of claim 5, wherein
the display screen displays the plurality of texts used for generating the summary in association with the summary in a manner that is editable by the user.

7. The summarizing system of claim 5, wherein
the display screen displays the summary in a manner that allows the user to extract, copy, or edit the summary.

8. The summarizing system of claim 5, wherein
the speech is collected during a conference in which content data is transmitted or received between a plurality of terminal apparatuses, and
the processing circuitry is configured to display the display screen superimposed on a conference screen provided for the conference.

9. The summarizing system of claim 4, wherein
the processing circuitry is configured to update the summary, after a first time period has elapsed since at least a part of the plurality of texts was changed for the first time or after a second time period has elapsed since at least a part of the plurality of texts was changed for the last time.

10. The summarizing system of claim 1, wherein
the processing circuitry stops updating the summary, in a case where the summary has been changed by a user input.

11. The summarizing system of claim 4, wherein
in response to reception of a predetermined operation by the user, the processing circuitry is configured to update the summary.

12. A summarizing method, comprising:
acquiring speech;
converting the speech into a plurality of texts;
generating a summary of the plurality of texts when the plurality of texts satisfy a summarizing execution condition; and
outputting the summary to a user.

13. A non-transitory recording medium storing a plurality of instructions which, when executed by one or more processors, causes the processors to perform a summarizing method, comprising:
acquiring speech;
converting the speech into a plurality of texts;
generating a summary of the plurality of texts when the plurality of texts satisfy a summarizing execution condition; and
outputting the summary to a user.
